(19) United States
(12) Patent Application Publication
(10) Pub. No.: US 2017/0109569 A1
(43) Pub. Date: Apr. 20, 2017

(54) HYBRID FACE RECOGNITION BASED ON 3D DATA

(71) Applicants: Hongtae Kim, Seoul (KR); Sungwook Su, Torrance, CA (US); Peter Yoo, Los Gatos, CA (US)

(72) Inventors: Hongtae Kim, Seoul (KR); Sungwook Su, Torrance, CA (US); Peter Yoo, Los Gatos, CA (US)

(21) Appl. No.: 15/249,373

(22) Filed: Aug. 27, 2016

Related U.S. Application Data
(60) Provisional application No. 62/211,396, filed on Aug. 28, 2015.

(51) Int. Cl. G06K 9/00; G06T 15/06

(52) U.S. Cl. CPC G06K 9/00288; G06T 15/06; G06K 9/00248

(57) ABSTRACT

Some embodiments provide a hybrid facial recognition method that processes both 2D and 3D data relating to the same person. In some embodiments, the method performs a first level facial recognition with one of the 2D and 3D data sets. The method then performs a second level facial recognition with the other remaining data set.

### CLAIM OF BENEFIT TO PRIOR APPLICATIONS

This application claims the benefit of U.S. Provisional Patent Application 62/211,396, filed on Aug. 28, 2015. U.S. Provisional Patent Application 62/211,396 is incorporated herein by reference.

### BACKGROUND

With the advent of technology, there are an increasing number of facial recognition algorithms. These algorithms generally operate on data values relating to a person's face. Typically, the data values are derived from a 2D photo of the person.

### BRIEF SUMMARY

Embodiments described herein provide a hybrid face recognition algorithm that is based on 3D data with additional enhancements from projected 2D face recognition algorithm. The most common facial recognition algorithms are based on 2D images. However, the facial recognition method of some embodiments is a hybrid recognition method that utilizes both 3D data and 2D photo data.

In some embodiments, the method is smart to switch back and forth between 2D and 3D data to find each facial element to get the best results, and transfer or convert the information between the 2D and 3D formats. In some embodiments, the method uses one or more depth sensors to capture the person's 3D data. The method then uses that 3D data to make a facial recognition. The method of some embodiments can also leverage or use one or more different (e.g., widely used) 2D facial recognition algorithms to produce even better results.

As indicated above, the method of some embodiments is a hybrid method that receives 2D and 3D data relating to a person. The 2D and 3D data are also referred to herein as 2D and 3D data sets or datasets.

After receiving the data sets, the method automatically identifies the person by performing a number of different operations. In some embodiments, the method performs a first level facial recognition with one of the 2D and 3D data sets. The method then performs a second level facial recognition with the other remaining data set. The method can continue switching between different types of data to provide the best results. In some embodiments, the method of some embodiments compares or provides both 2D and 3D data values relating to the same features of a person's face (e.g., the eyes, nose, ear, lips, etc.).

In processing 3D data set, the method of some embodiments processes depth information. The depth information may be specified in a depth map. In some embodiments, the depth map is an image that has data relating to the distance of the surface of the object(s) in a scene from a particular view point. The depth map is typically generated or captured from a viewpoint of a depth sensor.

In some embodiments, the method processes depth information to capture various data values relating to a person. Different embodiments can use one or more different parts, or one or more different physical features of a person to make a facial recognition or person identification. For instance, the method can use the size of one or more different parts of the person, such as the eyes, the nose, the hands, etc. The method can use other stats, measurements, and location information relating to the person's physical appearance (e.g., as captured with a depth sensor). Once the data values are captured, the method of some embodiments searches one or more databases to find a set match of matches.

In some embodiments, the 2D data set includes a photo with the person represented with RGB values. In some embodiments, the 2D data set includes a photo with the person represented with grayscale values. That is, to make facial identification, the method may use 2D color data that is defined in different bits (e.g., color, grayscale, black and white).

The method of some embodiments performs facial recognition with the 3D data set by setting a target object, which represents the person, with a bounding box. The bounding box contains a 3D representation of the sole target or person that is being identified. The method of some embodiments sets up or defines the target unit with an axis-aligned bounding box (AABB). This type of bounding box is aligned with the axes of a particular coordinate system. The axis bounding box can be used to determine a head rotation.

In some embodiments, the method uses 2D data to derive data values. The method then uses a set of data values, which is derived from the 2D data, to perform the recognition with the 3D data. For instance, in performing facial recognition with the 3D data set, the method of some embodiments converts initial point on 2D image data to 3D using ray-casting to increase accuracy of detection. This can entail executing ray-test on initial point of 3D mesh along the normal vector direction.

In some embodiments, the method finds features of person from the 2D data and uses the found features to supplement the detection at the 3D level. For example, a person's eyes can be found in the 2D space and sent back to 3D space for processing. Alternatively, or conjunctively with using 2D data in the 3D space, the method of some embodiments uses 3D data in the 2D space to perform the facial recognition.

The method of some embodiments finds one or more different body parts of the person from 3D data. The method of some embodiments finds a persons head or face. In some embodiments, the method performs a face detecting by measuring the width of the person's head. The width may be measured by calculating the distance from the outer edge of the person's one ear to outer edge of the person's other ear. After measuring the width, the method then processes the depth scan in the Y (vertical) direction (e.g., until the person's chin is found or until the top of head is found depending on the input of data).

In some embodiments, the method calculates data values relating to different parts of the persons. For instance, in some embodiments, the method determines face's degree of tilt. The degree value may used to measure other features of a person such as the person's arm and its depth, height, length, etc.

The method of some embodiments detects a person's nose from the person's face. In detecting, the method processes the depth scan data from the chin to the top of the head, or vice versa. In some embodiments, the depth scan is processed to find the tip of the nose or the highest point relative to the majority of the surface area of the person's face. In some embodiments, the tip of nose is the highest point from a surface point of the surface area of the person's face with respect to the face's tilt.

In some embodiments, the method identifies the depth of the nose based on the 3D data. The depth may be measured as the distance or range from the tip of the nose to the nose's base. In some embodiments, the method identifies the length of the nose. The length can be measured differently for different embodiments. For instance, the length can be the length of the nasal ridge, which is the length that extends from the tip of the nose to the root. The length can be measured from the nasion or the root to the lower end of one of the ala or nostril.

The method of some embodiments finds a person's nose from the face based on 3D data. In some embodiments, this entails finding the widest spot in cheekbone on the face and specifying the width of that spot as a maximum guideline. The method of some embodiments uses the guideline to find the person's eyes between the cheekbones. In some embodiments, there is about a two inch maximum limit to the width of the scan relative to the one end of the person's cheekbone to the other end of the person's other cheekbone.

The method of some embodiments finds one or more other facial feature to make the facial recognition. The method of some embodiments finds a person's ears or lips. The method can also gather data values relating to those detected facial features.

As indicated above, the method performs multiple levels of facial recognitions based on 2D and 3D data. In some embodiments, the first level facial recognition is a 3D recognition with the 3D data set, and the second level facial recognition is a 2D recognition with the 2D data set. In some embodiments, the first level facial recognition is a 2D recognition with the 2D data set, and the second level facial recognition is a 3D recognition with the 3D data set.

As stated above, the method is smart enough to switch back and forward between 2D and 3D data. For instance, the method may perform the first level facial recognition and then performing the second level facial recognition only if the first level recognition fails. Alternatively, the method may perform the first level facial recognition and then perform the second level facial recognition regardless of whether the first one fails or not. In some embodiments, the switching back and forth between 2D and 3D data sets comprises performing the first level facial recognition, then performing the second level facial recognition, and then performing a third level facial level recognition, or as many recognition levels required to provide the best results.

Depending on the input 2D and 3D data, the results of the method can vary. For instance, the results from the different levels can include the same or conflicting results relating to the identity of the person.

In some embodiments, one of the two sets of data (2D or 3D) is used to filter down the identification to a shorter list of people. For instance, the method can derive the person's height from 3D data and then used the height to search a smaller group of people using 2D data. In some embodiments, the method uses data values derived from 3D data to support the result with the 2D data. For instance, the results can include a facial recognition with 2D data that is supported by a person or facial recognition with 3D data.

In some embodiments, performing the facial recognition with 2D or 3D data comprises analyzing the geometric features of a face, such as the eyes, the nose, the ear, etc. The geometric features can include location of the various features with respect to the face or the head. In some embodiments, the facial recognition comprises analyzing the size(s) of feature(s) of the face, such as the eyes, nose, ears, etc. In some embodiments, the facial recognition operations comprise analyzing the position information or angular information relating to a particular feature of the face or head. In some embodiments, the facial or person recognition operations (e.g., with the 3D data) comprise comparing data values relating to parts of the person's body other than the person's head or face.

In some embodiments, the first or second level facial recognition includes treating or altering the 2D or 3D data. This is to alter the person's appearance in some manner. This may be done to provide a visual reference with the 2D and/or 3D data. For instance, the data values relating to a person's weight can be changed to display the person with the changed weight. Treatments may include changing the person's age, the person's size, and the person's weight.

In some embodiments, the method performs the facial recognition with the 2D data set by finding the pupils from the face or head represented in the 2D image. In finding the pupils in the 2D image, the method may use 2D pattern matching algorithm to find the pupils. This is because pupils are circular in shape. In some embodiments, the method finds the pupils by generating low resolution representation of the person's eyes. For instance, the method can resize the eye image to a low-resolution image. This allows each pupil to occupy only a couple of pixels in the image (e.g., 3-4 pixel in the image).

Further, some embodiments provide a non-transitory machine readable medium storing a program for execution by at least one processing unit. The program comprising sets of instruction for performing the recited operations of the above-described method. Furthermore, some embodiments provide a computing device (e.g., mobile device such as smart phone, computer, etc.) that performs the recited operations of the above-described method.

Also, some embodiments provide a system. The system has a first set of computing devices to capture 2D and 3D data. The system also has a second set of computing devices to receive the 2D and 3D data from the first computing device, and perform a hybrid facial recognition with the 2D and 3D data. In some embodiments, the, hybrid facial recognition includes (1) receiving 2D and 3D data sets relating to a person; and (2) automatically identifying the person by: (i) performing a first level facial recognition with one of the 2D and 3D data sets, and (ii) performing a second level facial recognition with the other remaining data set.

Furthermore, some embodiments provide a method of performing facial recognition. The method comprises (1) receiving 2D and 3D data sets relating to a person; and (2) performing a hybrid facial recognition by: (i) using 2D data to derive data values, and (ii) using a set of data values, which is derived from the 2D data, to perform the hybrid facial recognition with the 3D data. In some embodiments, this method uses 2D data by converting initial point data on 2D image data (e.g., relating to one or more facial features such as the eyes, nose, etc.) to 3D data using ray-casting.

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a system that utilizes the hybrid facial recognition algorithm according to some embodiments of the invention.

FIG. 2 shows a process that some embodiments perform to identity a person.

FIG. 3 shows another process that some embodiments perform to identity a person.

FIG. 3 shows example operations performed by the hybrid process 300 to identity a person.

FIG. 4 shows a process that some embodiments implement to detect a person's face and to derive data values relating to the face.

FIG. 5 shows a facial recognition program detecting a person's head from 3D.

FIG. 6 shows the recognition program scanning the face data to derive data values.

FIG. 7 shows a process that some embodiments implement to detect a person's nose and derive data values relating to the nose.

FIG. 8 shows a recognition program scanning the face data to detect the person's nose.

FIG. 9 shows a process that some embodiments implement to find a person's eyes.

FIG. 10 shows a recognition program scanning the face to find a person's eyes.

FIG. 11 shows an example of finding a person's ear by scanning 3D data associated with the side of the person's head.

FIG. 12 conceptually shows pattern matching on 2D data to find a person's feature.

FIG. 13 shows an example of a recognition program finding the pupils by performing a pattern matching test.

FIG. 14 shows the result of the pattern matching test of FIG. 13.

FIG. 15 shows a normal map supplementing 2D recognition in the recognition program.

FIG. 16 shows an example of a recognition program tracing a person's eye.

FIG. 17 conceptually shows the recognition program sub-dividing the picture of a person's eye.

FIG. 18 conceptually shows an example of making an outline of a person's eye.

FIG. 19 conceptually shows an example of tracing a person's eyes.

FIG. 20 shows using a grayscale image and a normal map to find the lips.

FIG. 21 shows an example of tracing a person's lips.

FIG. 22 conceptually illustrates an electronic system with which some embodiments of the invention are implemented.

FIG. 23 shows an example of an architecture of a mobile computing device.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Embodiments described herein provide a hybrid face recognition algorithm that is based on 3D data with additional enhancements from projected 2D face recognition algorithm. The most common facial recognition algorithms are based on 2D images. However, the facial recognition method of some embodiments is a hybrid recognition method that utilizes both 3D data and 2D photo data.

In some embodiments, the method is smart to switch back and forth between 2D and 3D to find one or more facial elements to get the best results, and to transfer or convert the information between the 2D and 3D formats. In some embodiments, the method uses one or more depth sensors to capture the person's 3D data. The method then uses that 3D data to make a facial recognition. The method of some embodiments also leverages one or more different (e.g., widely used) 2D facial recognition algorithms to produce even better results.

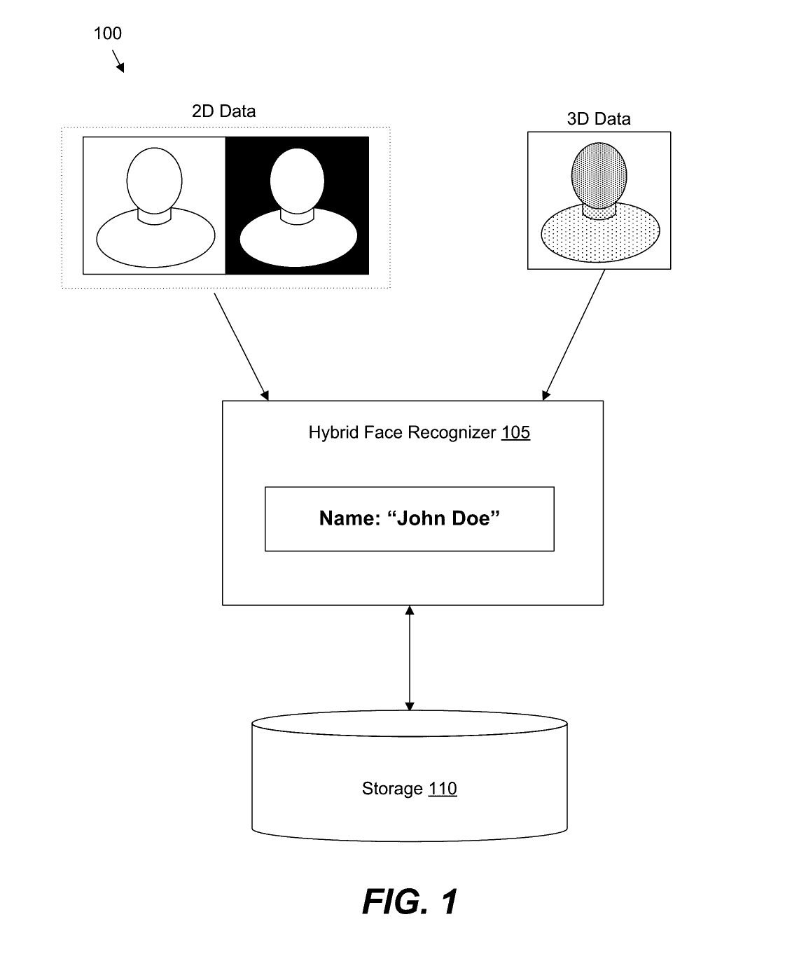

FIG. 1 conceptually illustrates a system 100 that utilizes the hybrid facial recognition algorithm according to some embodiments of the invention. The hybrid facial recognition algorithm analyzes 2D and 3D data relating to a person. The figure shows (1) a hybrid face recognizer 100 that runs the hybrid facial algorithm and (2) storage 105 that stores identifying data relating to different people. The operations of the system 200 will be described below after an introduction of these elements.

The hybrid face recognizer 105 operates on one or more machines or devices to perform facial recognition with 3D data. For instance, the recognizer 105 may be a program executing on a computing device, such as a computer, mobile device, laptop, etc. Instead of one device performing the recognition task, the task can be spread out across a number of devices. For instance, there can be one set of machines performing the 2D facial recognition operations and another set of machines performing the 3D facial recognition operations.

In some embodiments, the recognizer 105 processes depth information. The depth information may be specified in a depth map. In some embodiments, the depth map is an image that has data relating to the distance of the surface of the object(s) in a scene from a particular view point. The depth map is typically generated from a viewpoint of a depth sensor.

In some embodiments, the recognizer 105 processes depth scans of the same person from different distances to provide the facial recognition results. For instance, the recognizer may process a first depth map with a close up of the head, and process a second depth map with a full body shot.

In some embodiments, the recognizer 105 processes depth information in order to capture various data values relating to a person. Different embodiments can use one or more different parts, or one or more different physical features of a person to make a facial recognition. For instance, the recognizer 105 can use the sizes of different parts of a person, such as the eyes, the nose, the hands, etc. The recognizer 105 can use other stats, measurements, and location information relating to the person's physical appearance (e.g., as captured with one or more depth sensors). Once the data values are captured, the recognizer searches the storage 110 to identity the person.

In some embodiments, the recognizer 105 processes one or more different types of 2D data. As shown in FIG. 1, the recognizer 105 can process a photo with the person represented with RGB values. Alternatively, or conjunctively, the recognizer 105 can process a photo with the person represented with RGB values. That is, to make a facial recognition, the method may use 2D color data represented in different bits (e.g., color, grayscale, black and white).

In some embodiments, the recognizer 105 performs facial recognition with the 3D data set by setting a target object, which represents the person, with a bounding box. The bounding box contains or surrounds a 3D representation of the sole target or person that is being identified. The method of some embodiments sets up the target unit with an axis-aligned bounding box (AABB). This type of bounding box is aligned with the axes of a particular coordinate system.

In performing facial recognition with the 3D data set, the recognizer 105 of some embodiments converts initial point on 2D image data to 3D using ray-casting to increase accuracy of detection. This can entail executing ray-test on initial point of 3D mesh along the normal vector direction.

The recognizer 105 of some embodiments detects or finds one or more different body parts of the person from 3D data. The recognizer of embodiments finds a person head or face. In some embodiments, the recognizer captures data relating to a persons facial feature or other bodily features. In some embodiments, the recognizer calculates data values relating to different parts of the person. For instance, in some embodiments, the recognizer determines face's degree of tilt. The degree value may used to derive other measurements relating to the person, such the width of the person's body parts, the length, the depth, etc.

Further, the recognizer 105 of some embodiments uses some other combination of data, or one or more other types of identifying data to make the facial or person recognition. As an example, the method may use other biometric data (e.g., retina scan, fingerprint, voice data, etc.) to supplement or support the result with the 3D data.

The storage 110 stores various identifying data relating to different people. The identifying data includes 2D and 3D data. Although FIG. 1 shows only one storage 110, the system may store the identifying data with a number of databases. With today's technology, the identifying data can reside in multiple different storage devices at the same time in one or more data centers.

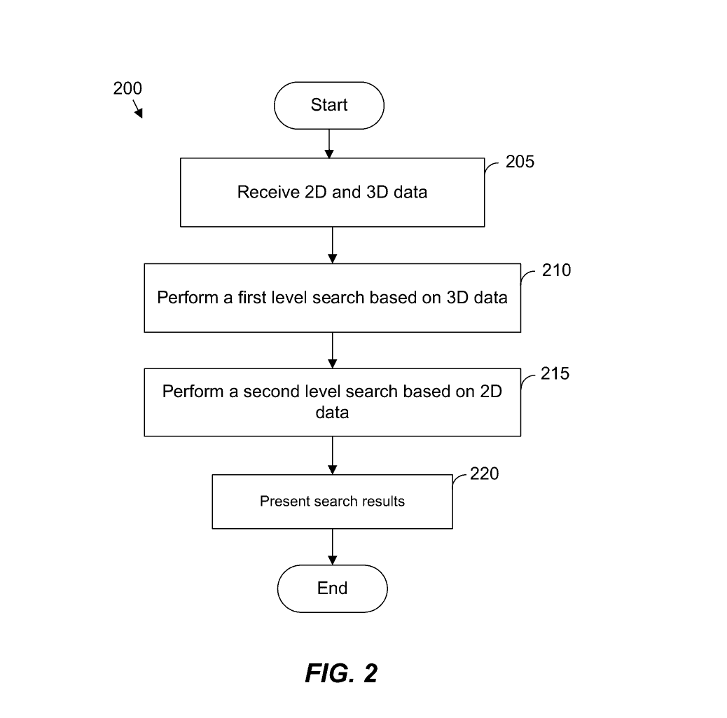

Having described the elements of the system, the operation of the system 100 will now be described by reference to FIG. 2. FIG. 2 shows a process 200 that some embodiments perform to identity a person. In some embodiments, the process 200 is performed by one or more programs operating on one or more computing devices.

As shown, the process 200 begins by receiving (at 205) 2D and 3D data. The process 200 then performs (at 210) a first level search based on 3D data. After performing the first level, the process 200 performs (at 215) a second level search based on the 3D data.

Referring to FIG. 1, the recognizer 105 receives and processes 2D and 3D data. The 2D and 3D data may be received remotely from one or different computing devices (not shown). For instance, the 2D and 3D data may be sent over a network from one computing device to another. The data may be received locally if the data was captured locally. For instance, the 2D and 3D data may be captured with and processed by the same mobile computing device.

After receiving the 2D and 3D data, the recognizer 105 processes the data to derive data values relating to the person. The recognizer then searches the storage 110 to find one or more matching entries.

Referring to FIG. 2, after performing the multi-level search, the process 200 presents (at 220) the results. The process 200 then ends.

In the example of FIG. 1, the facial recognition with the 2D and 3D data resulted in the recognizer displaying the name of the person. This is conceptually shown with the name “John Doe” appearing in a user interface (UI) 115 (e.g., search results display area).

Some embodiments perform variations of the process 200. The specific operations of the process 200 may not be performed in the exact order shown and described. The specific operations of the process 200 don't have to be performed in one continuous series of operations, and different specific operations may be performed in different embodiments. For instance, in some embodiments, the first level facial recognition is a 2D recognition with the 2D data set, and the second level facial recognition is a 3D recognition with the 3D data set. Also, for instance, in some embodiments, the first level recognition is with 3D data and the second level is with a different type of identifying information (e.g., fingerprint data, voice data, etc.).

Many more examples of the hybrid facial recognition method are described below. Specifically, Section I describes an example process that some embodiments perform to identify a person. Section II then describes several example operations performed with 3D data. This is followed by Section III that describes how some embodiments use 2D data to perform the hybrid facial recognition method. Section IV then describes several example electronic systems for implementing some embodiments of the invention.

### I. Example Process

In some embodiments, the hybrid facial recognition method performs a number of steps or operations to provide the best results.

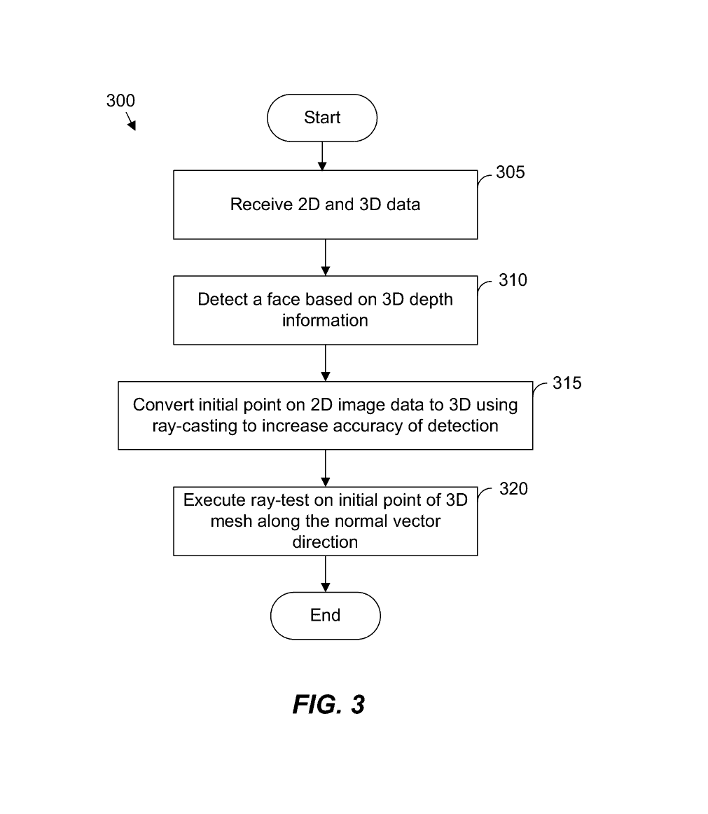

FIG. 3 shows example operations performed by the hybrid process 300 to identity a person. In some embodiments, the process 200 is performed by one or more programs operating on one or more computing devices.

As shown in FIG. 3, the process 300 begins by receiving (at 305) 2D and 3D data. The process 300 detects (at 310) a face based on 3D depth information. The process 300 then converts (at 315) initial point on 2D image data to 3D data using ray-casting to increase accuracy of detection. The process then executes (at 320) a ray-test on initial point of 3D mesh along the normal vector direction.

Some embodiments perform variations of the process 300. The specific operations of the process may not be performed in the exact order shown and described. The specific operations of the process don't have to be performed in one continuous series of operations, and different specific operations may be performed in different embodiments.

II. Example Operations with 3D Data

As stated above, the method of some embodiments processes 3D data to identify a person. In some embodiments, the method finds a person's face from 3D data. The method then derives several data values relating to the face. The method can also find one or more facial features, and derive data values associated with the one or more facial features.

A. Face Detection

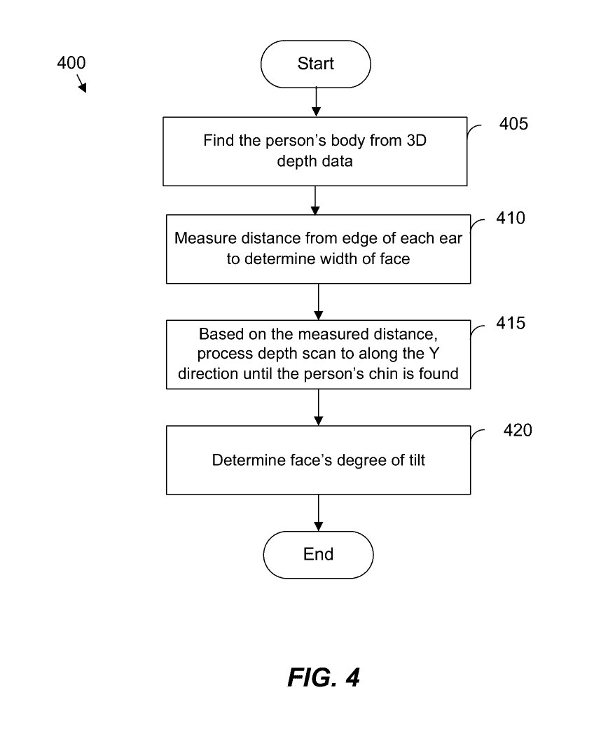

In some embodiments, the recognition method finds a person's face from 3D data. FIG. 4 shows a process 400 that some embodiments implement to detect a person's face and derive data values relating to the face. In some embodiments, the process 400 is performed by one or more programs operating on one or more computing devices.

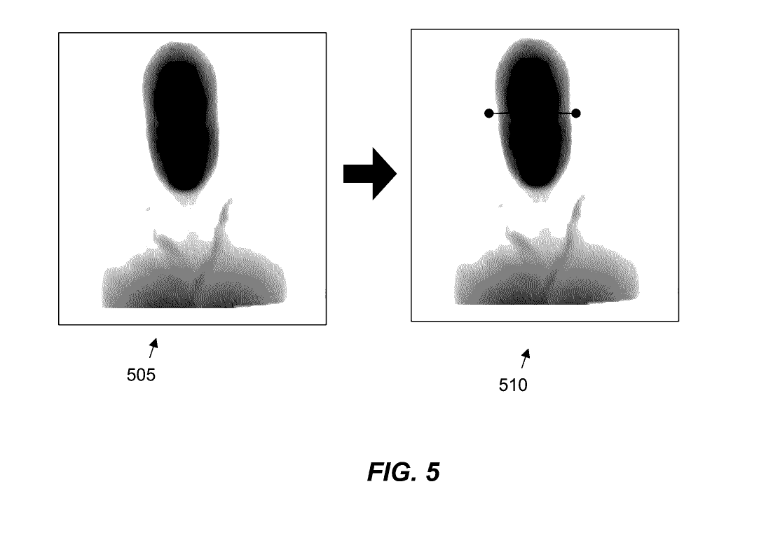

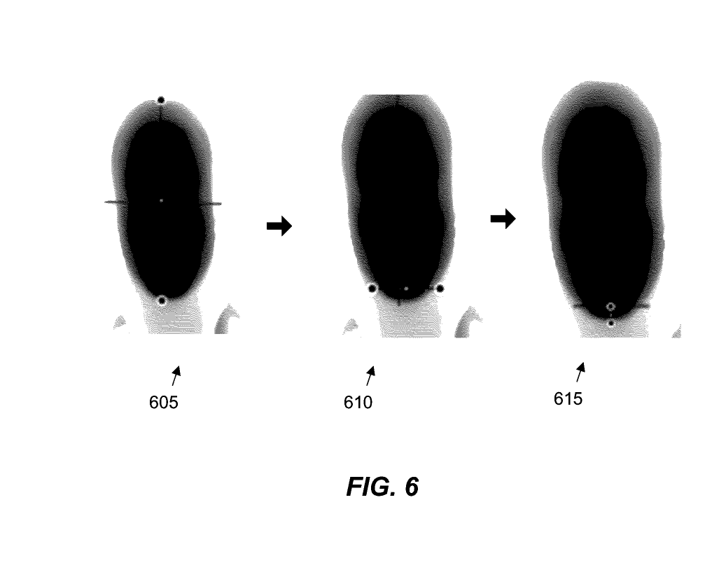

FIG. 4 will be described by reference to FIGS. 5 and 6. FIG. 5 shows a facial recognition program detecting a person's head from 3D. FIG. 6 shows the recognition program scanning the face data to derive data values.

As shown in FIG. 4, the process 400 first iterates through the 3D depth scan data to find (at 405) the person's body. In some embodiments, the process 400 scans through the depth scan data to identity an object from the scan data that appears to be a person's body. The process 400 might then analyze or scan the person's body to find the person's head or face.

Referring to FIG. 5, in the first operational stage 505 of the recognition program, the process 400 might first find the person's body. As shown in the second stage 510, the process might then find the face or the head.

In some embodiments, the process 400 derives data relating to the face. As shown in FIG. 4, the process 400 can measure (at 410) the width of the face.

Different measurements can be calculated differently in different embodiments. For instance, in the second stage 510 of FIG. 5, the width of the head or face is measured as the distance from the outer edge of one ear to the outer edge of the other ear.

Referring to FIG. 4, the process 400 of some embodiments processes (at 415) the depth scan data along the Y direction until the person's chin is found. The process 400 then determines (at 420) the face's degree of tilt. These operations are conceptually shown in the three stages 605-615 of FIG. 6.

In the first stage 605, the program is scanning through the data associated with the person's head. The scan begins from the top of the head and proceeds until the chin is found. This is shown with the scanline or guideline moving from the middle of the head in the first stage 605 towards or near the chin in the second stage 610. In the third stage 615, the process 400 determines the degree of tilt of the person's face.

As shown in FIG. 4, after deriving several data values, the process 400 ends. Some embodiments perform variations of the process 400. The specific operations of the process don't have to be performed in the exact order shown and described. The specific operations of the process may not be performed in one continuous series of operations, and different specific operations may be performed in different embodiments.

B. Nose Detection

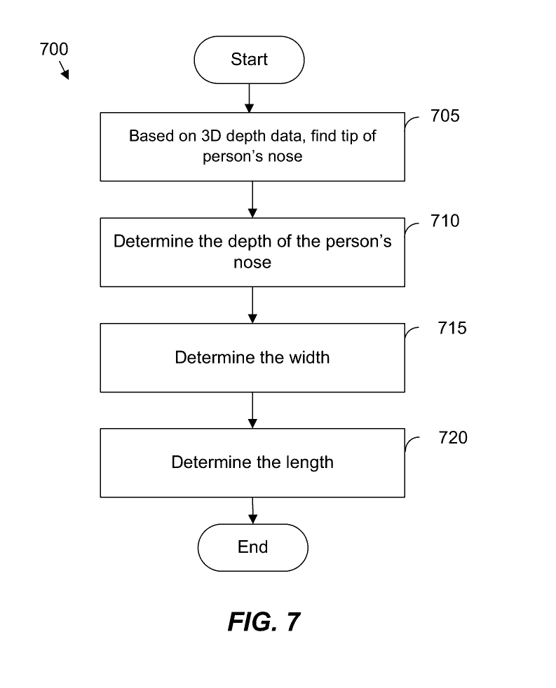

In some embodiments, the recognition method finds a person's nose from 3D data. FIG. 7 shows a process 700 that some embodiments implement to detect a person's nose and derive data values relating to the nose. In some embodiments, the process 700 is performed by one or more programs operating on one or more computing devices.

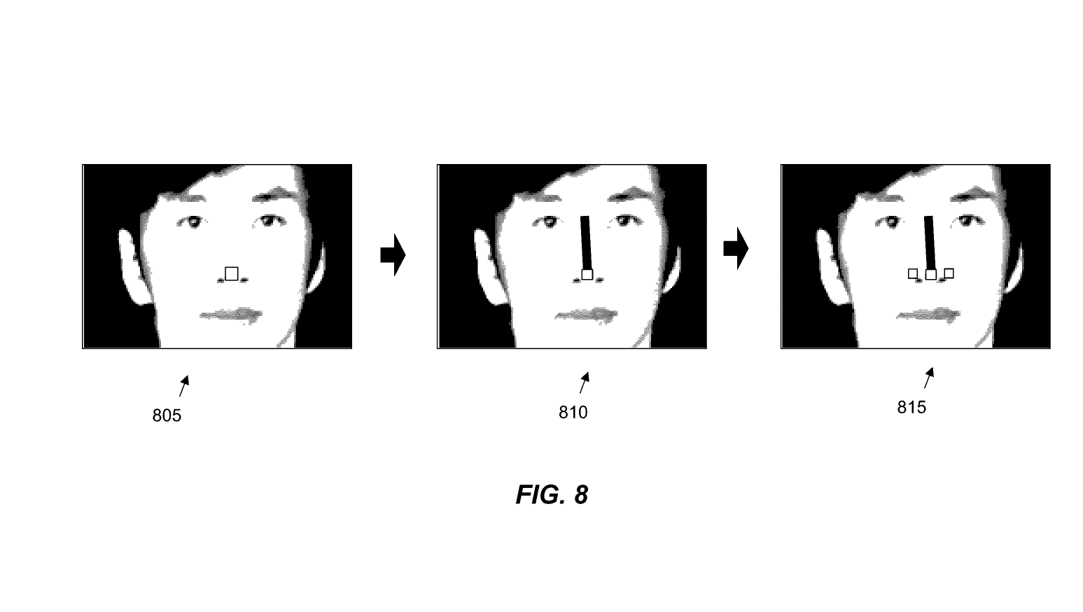

FIG. 7 will be described by reference to FIG. 8. FIG. 8 shows a recognition program scanning the face data to detect the person's nose.

The process of some embodiments finds one or more different parts of a human feature. For instance, in FIG. 7, the process 700 finds (at 705) the tip of the person's nose. The process can also find other parts or features relating to the nose, such as the bridge, nostril, etc.

The process of some embodiments derives data values relating to the feature. For instance, in FIG. 7, the process 700 determines (at 710) the depth of the nose. The process then determines (at 715) the width of the nose. The process then determines (at 720) the length of the nose.

The operations of the process 700 are conceptually shown with the three stages of FIG. 8. In the first stage 805, the recognition program finds the tip of the person's nose. After finding the tip, the program might then use the information to find the depth of the nose. In the second stage 810, the program finds the length of the nose. In the third stage 815, the program determines the width of the nose.

As shown in FIG. 7, after deriving several data values, the process 700 ends. Some embodiments perform variations of the process 700. The specific operations of the process don't have to be performed in the exact order shown and described. The specific operations of the process don't have to be performed in one continuous series of operations, and different specific operations may be performed in different embodiments.

C. Finding the Eyes

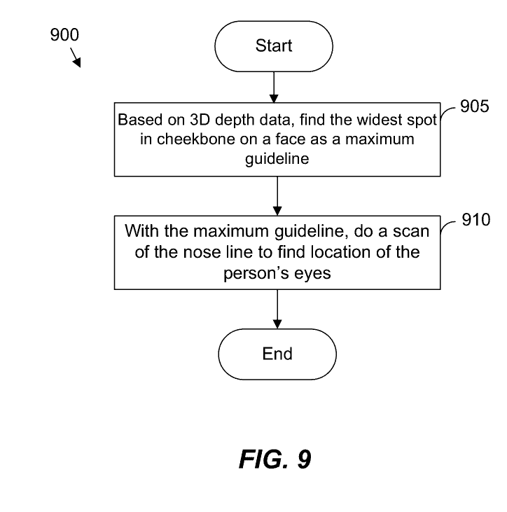

In some embodiments, the recognition method finds a person's eyes from 3D data and derives data relating to the eyes. FIG. 9 shows a process 900 that some embodiments implement to find a person's eyes. In some embodiments, the process 900 is performed by one or more programs operating on one or more computing devices.

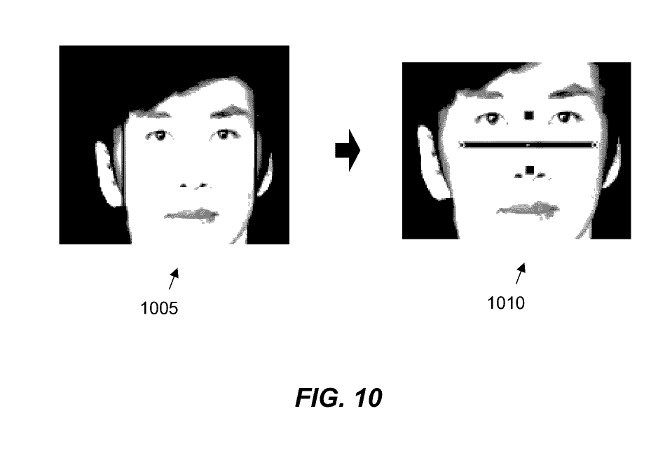

FIG. 9 will be described by reference to FIG. 10. FIG. 10 shows a recognition program scanning the face to find the person's eyes.

As shown in FIG. 9, the process 900 begins by finding (at 905) the widest line near the cheekbones on a person's face and specifies the widest line as the maximum guideline. At 610, the process 900 does a scan of the nose line to find location of the person's eyes.

The operations of the process 900 are conceptually shown with the two stages 1005 and 1010 of FIG. 10. In the first stage 1005, the recognition program finds the tip of the person's check bones to specify a scanline or guideline. In the second stage 1015, the recognition program scans the 3D data in a vertical direction across the person's nose to find the person's eyes.

As shown in FIG. 9, after finding the eyes, the process 900 ends. Some embodiments perform variations of the process 900. The specific operations of the process don't have to be performed in the exact order shown and described. The specific operations of the process don't have to be performed in one continuous series of operations, and different specific operations may be performed in different embodiments.

D. Detecting Different Body Parts

As mentioned, the method processes depth information to capture various data values relating to a person. Different embodiments can use one or more different parts, or one or more different physical features of a person to make a facial recognition or person identification. For instance, the method can use the size of one or more different parts of a person, such as the eyes, the nose, the hands, etc. The method can also use other statistics, measurements, and location information relating to the person's physical appearance (e.g., as captured with a depth sensor).

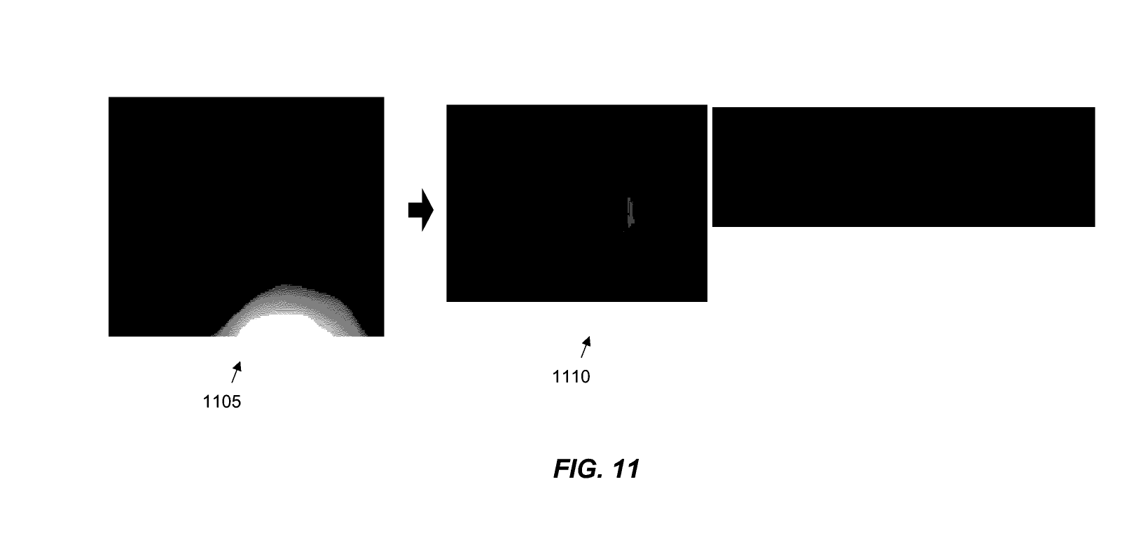

In some embodiments, the recognition method scans 3D data associated with the sides of a person's head to find the ears. FIG. 11 shows an example of finding a person's ear by scanning 3D data associated with the side of the person's head. In particular, the first stage 1105 shows the program receiving depth data relating to a person. In the second stage 1110, the recognition program scans data relating to the side of the person's head. The results of the search are shown on the right next to the second stage 1110.

In some embodiments, the recognition method finds a body part by reference to one or more other body parts. For instance, in the example of FIG. 11, the recognition program analyzed the depth data to find the ear area based on nose height position.

III. Example Operations with 2D Data

As indicated above, the method of some embodiments is smart enough to switch back and forth between 2D and 3D data to find one or more facial elements.

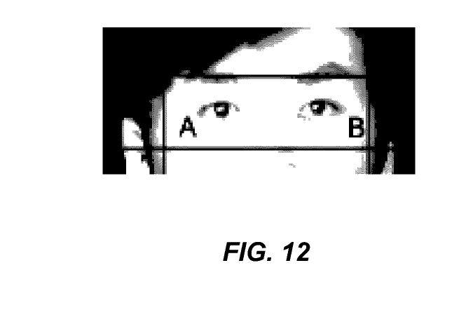

In some cases, finding the pupils in 2D data is faster and better than in 3D data. So, in some embodiments, the process use 2D pattern matching algorithm. FIG. 12 conceptually shows performing pattern matching on 2D data to find a person's feature. Specially, the figure shows scanning the eyes to find circle shapes that represent the pupils.

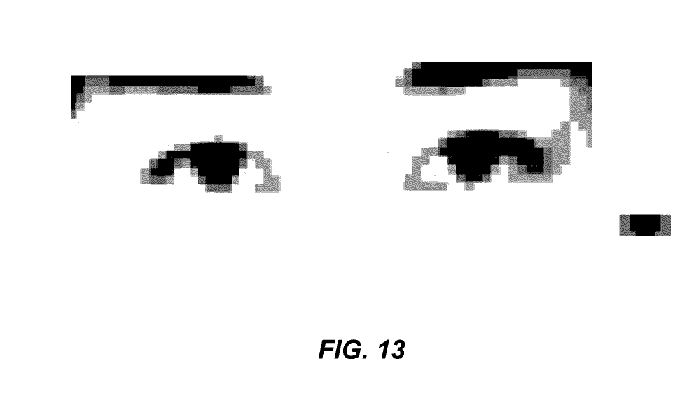

In some embodiments, the process formats data to match patterns. FIG. 13 shows an example of a recognition program attempting to find the pupils by performing a pattern matching test. Here, the pictures on the left are images that have been scaled down. On the right is a 9×4 pixel test pattern for searching each eye.

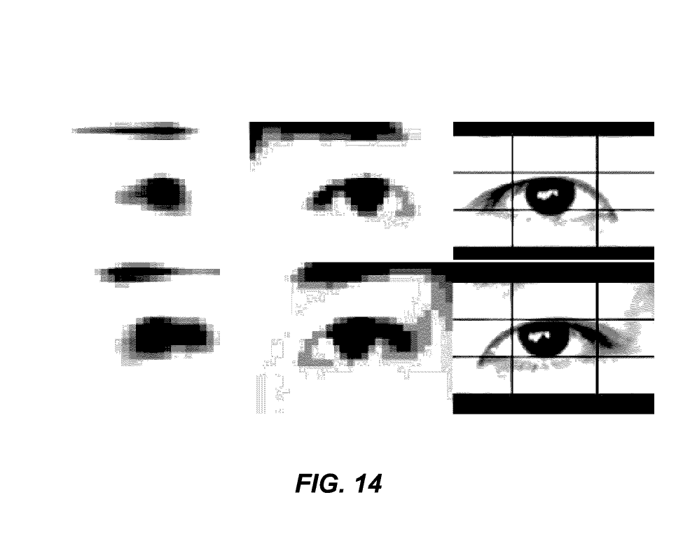

FIG. 14 shows the result of the pattern matching test. The pictures on the left are the results of pattern matching, while those on the right show the search for the pupils in a confined area. In some embodiments, the process uses the following formula to perform the pattern matching operations: abs (pixel value−pattern value)*normal.

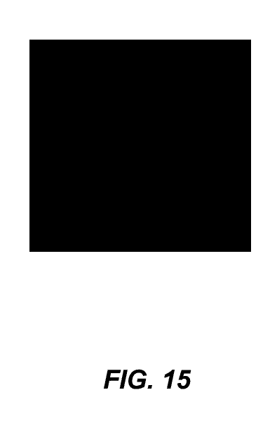

In some embodiments, the recognition method uses 3D data to supplement the 2D recognition. FIG. 15 shows a recognition program processing a normal map 1400 to supplement the 2D recognition.

The picture shown in FIG. 15 is a normal render image generated by the recognition program. The brighter areas are the ones facing the camera, and the darker areas are the ones getting close to being perpendicular with the camera. In some embodiments, the recognition method uses such a normal map to reduce pattern matching error caused by hair interference and other issues.

A normal map is typically an image used to provide additional 3D detail to a surface by changing the shading of pixels so that the surface appears angular rather than completely flat. The normal map or some other map (e.g., a heightmap) can also be used to supplement the 2D or 3D recognition. Different embodiments can use different maps. For instance, the system may use a bump map or some other map to provide the best recognition results.

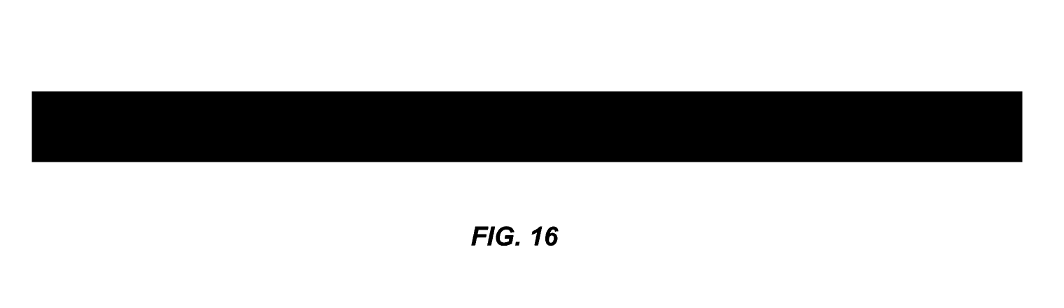

In some embodiments, the recognition method processes 2D or 3D data to trace a human feature. FIG. 16 shows an example of tracing a person's eye. In tracing, the method of some embodiments uses color tolerance to find whites of eye and increase threshold value until a good eye shape is found. The method then finds a number of tracing points (e.g., 12 tracing point) on each eye. The method then traces the eye.

As shown in FIG. 16, the recognition method detects certain colors to find facial features. The recognition method also adjusts the threshold value to change the color tolerance. In some embodiments, the tolerance defines the amount of variations in color the facial recognition method can accept.

In the example of FIG. 16, there are six thumbnail images of a person's eye. Each thumbnail represents a trace operation with a given threshold parameter. The threshold values for the different trace operations are as follows from left to right: 0, 0.1, 0.2, 0.3, 0.4, and 0.5.

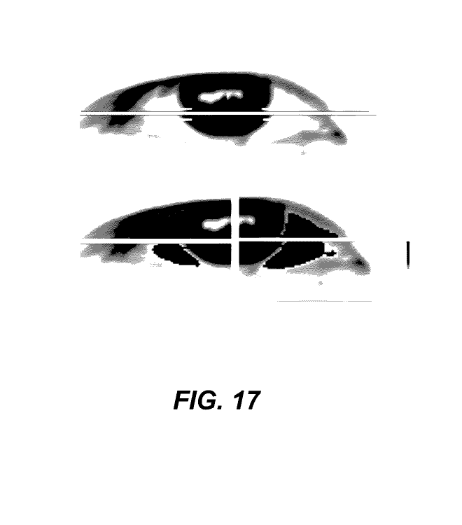

In some embodiments, to make a 2D recognition, the recognition method subdivides an image of a person's feature. FIG. 17 conceptually shows the recognition program sub-dividing the picture of a person's eye. In particular, the two pictures of FIG. 17 shows that the recognition program can sub-divide an image of the person's eye to find the person's pupil or some other feature(s) such as the white of the eye (i.e., sclera). The second picture of FIG. 17 also shows the searched areas of the eye. This is conceptually shown with the colored area next to the pupil.

FIG. 17 also shows that the reception method of some embodiments divides a picture of a person's eye into four sections. The figure also shows that the eye can be divided from center of pupil. One of the reasons for dividing the image portion is because the shadow on eye makes different brightness on white area. To get better result, the data of the facial feature can be sub-divided into different sections and then processed independently of one another.

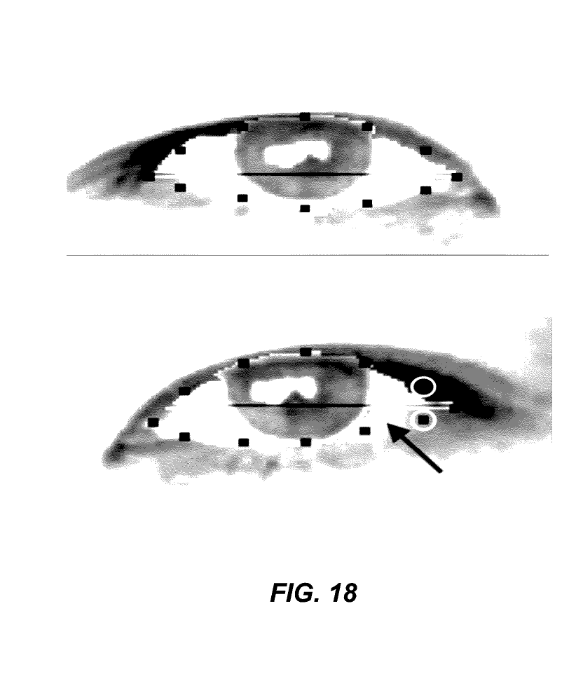

FIG. 18 conceptually shows an example of making an outline of a facial feature. Specifically, the figure shows the left and right eyes of a person being traced or outlined with the program. As indicated above, the recognition program of some embodiment finds the pupils as well. If the results of trace do not produce a satisfactory result, the recognition program can apply interpolation. For instance in the bottom picture of FIG. 18, the arrow shown in the picture conceptually illustrate interpolating data values to trace an outline of the person's eye.

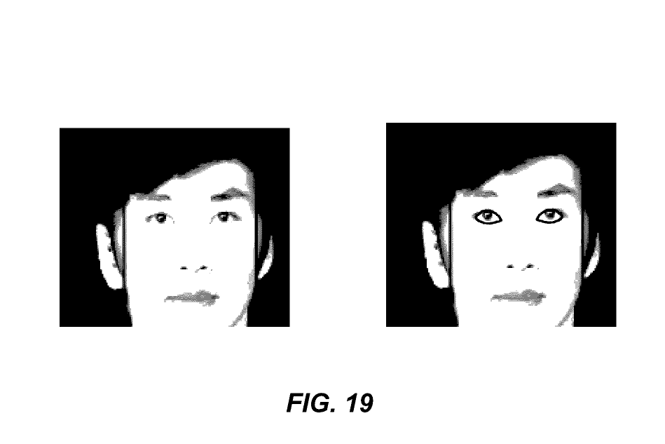

FIG. 19 conceptually shows an example of tracing the person's eyes. The picture on the left shows a 2D image prior to being processed with the trace algorithm, and the picture on the right shows the 2D image after being processed with the trace algorithm.

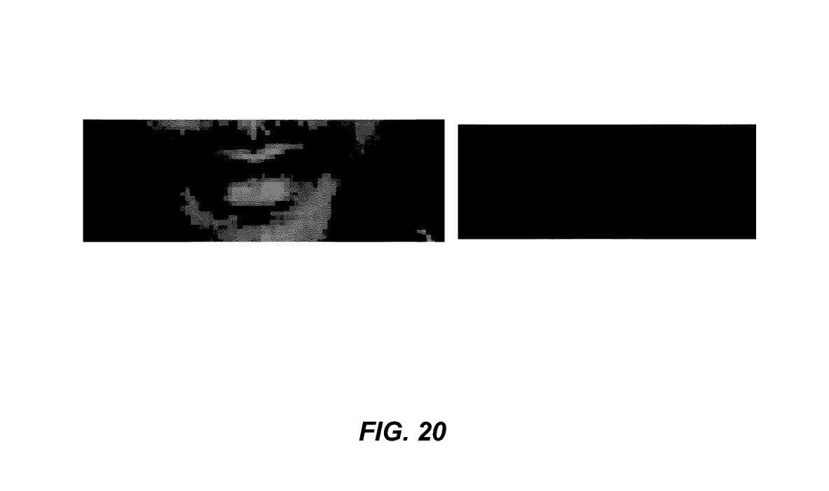

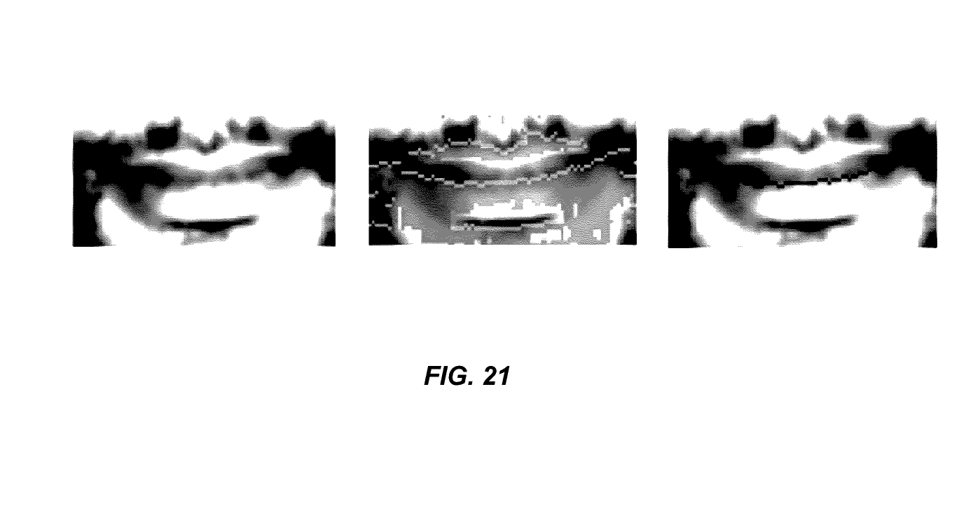

As indicated above, the method of some embodiments uses 3D data when processing 2D data. FIGS. 20 and 21 show finding an example of finding a person's lips in 2D data based on 3D data.

FIG. 20 shows using a grayscale image (left image) and a normal map (right image) to find the lips. The image shown on the left represents the grayscale image, while the image shown on the right represents the normal map.

FIG. 21 shows an example of tracing the lips. Specifically, the first image on the left shows a grayscale image of person's lips.

The second image of FIG. 21 conceptually show using depth information to get the width of lip and using the brightness of image to find the height of the lip. Here, the lighter gray color represents the point it begins to start getting darker around the lips, and the darker gray color represents all dark areas that are found which deviate from the lighter point.

The dark lines of the third image of FIG. 21 are the results that are made with all the lighter dots of the second image.

### IV. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Computer System

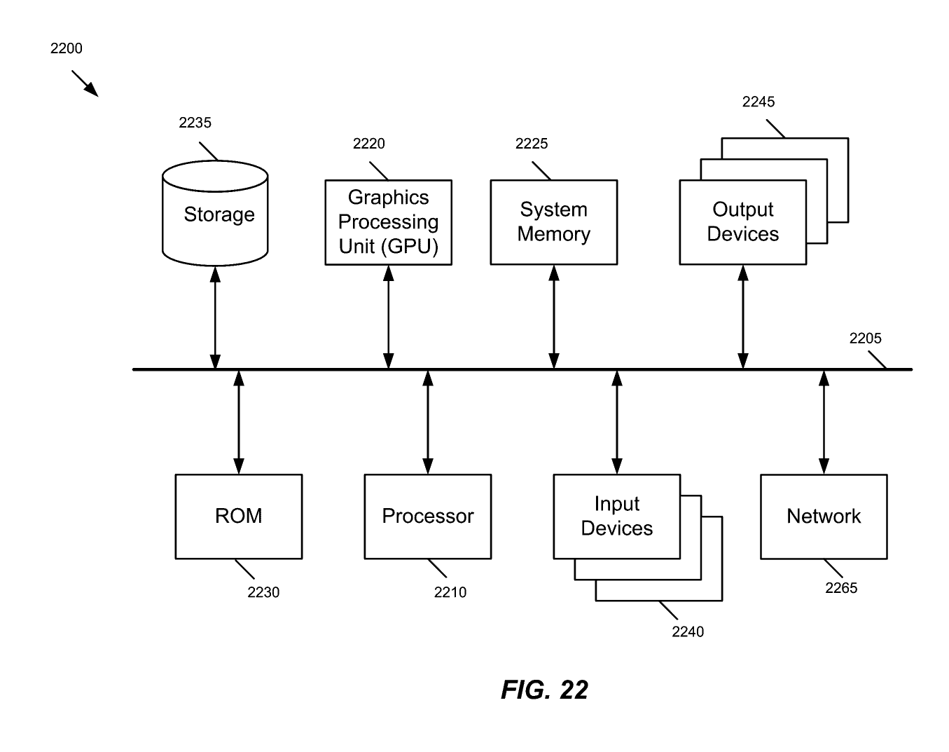

In some embodiment, one or more of the recognition system's programs operate on a computer system. FIG. 22 conceptually illustrates an electronic system 2200 with which some embodiments of the invention are implemented. The electronic system 2200 may be a computer (e.g., a desktop computer, personal computer, tablet computer, etc.), server, dedicated switch, phone, PDA, or any other sort of electronic or computing device. Such an electronic system includes various types of computer readable media and interfaces for various other types of computer readable media. Electronic system 2200 includes a bus 2205, processing unit(s) 2210, a system memory 2225, a read-only memory 2230, a permanent storage device 2235, input devices 2240, and output devices 2245.

The bus 2205 collectively represents all system, peripheral, and chipset buses that communicatively connect the numerous internal devices of the electronic system 2200. For instance, the bus 2205 communicatively connects the processing unit(s) 2210 with the read-only memory 2230, the system memory 2225, and the permanent storage device 2235.

From these various memory units, the processing unit(s) 2210 retrieves instructions to execute, and data to process in order to execute the processes of the invention. The processing unit(s) may be a single processor or a multi-core processor in different embodiments.

The read-only-memory (ROM) 2230 stores static data and instructions that are needed by the processing unit(s) 2210 and other modules of the electronic system. The permanent storage device 2235, on the other hand, is a read-and-write memory device. This device is a non-volatile memory unit that stores instructions and data even when the electronic system 2200 is off. Some embodiments of the invention use a mass-storage device (such as a magnetic or optical disk and its corresponding disk drive) as the permanent storage device 2235.

Other embodiments use a removable storage device (such as a floppy disk, flash memory device, etc., and its corresponding drive) as the permanent storage device. Like the permanent storage device 2235, the system memory 2225 is a read-and-write memory device. However, unlike storage device 2235, the system memory 2225 is a volatile read-and-write memory, such a random access memory. The system memory 2225 stores some of the instructions and data that the processor needs at runtime. In some embodiments, the invention's processes are stored in the system memory 2225, the permanent storage device 2235, and/or the read-only memory 2230. From these various memory units, the processing unit(s) 2210 retrieves instructions to execute and data to process in order to execute the processes of some embodiments.

The bus 2205 also connects to the input and output devices 2240 and 2245. The input devices 2240 enable the user to communicate information and select commands to send to the electronic system. The input devices 2240 include alphanumeric keyboards and pointing devices (also called “cursor control devices”), cameras (e.g., webcams), microphones or similar devices for receiving voice commands, etc. The output devices 2245 display images generated by the electronic system or otherwise output data. The output devices 2245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 22, bus 2205 also couples electronic system 2200 to a network 2265 through a network adapter (not shown). In this manner, the computer can be a part of a network of computers (such as a local area network (“LAN”), a wide area network (“WAN”), or an Intranet, or a network of networks, such as the Internet. Any or all components of electronic system 2200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as those produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

A. Mobile Device

In some embodiment, one or more of the system's recognition programs operate on a mobile device. In some embodiments, the recognition program processes 2D and 3D data captured with a mobile device.

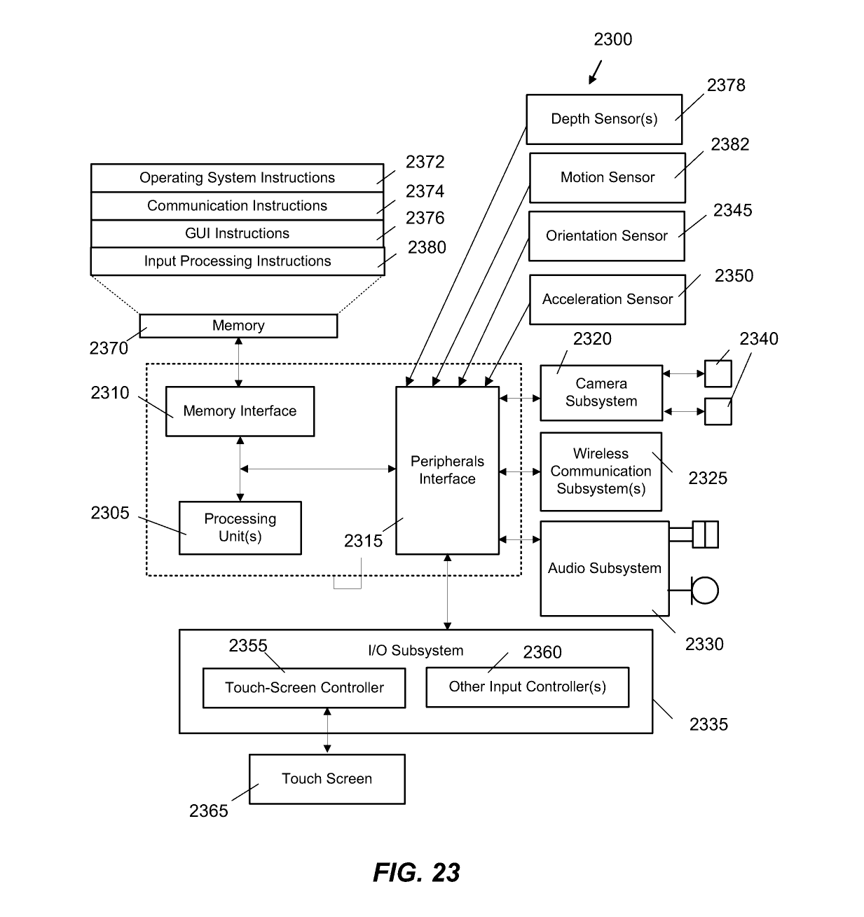

FIG. 23 shows an example of an architecture 2300 of such a mobile computing device. Examples of mobile computing devices include smartphones, tablets, laptops, etc. The mobile computing device is also a capturing device, in some embodiments. As shown, the mobile computing device 2300 includes one or more processing units 2305, a memory interface 2310 and a peripherals interface 2315.

The peripherals interface 2315 is coupled to various sensors and subsystems, including a camera subsystem 2320, a wireless communication subsystem(s) 2325, an audio subsystem 2330, an I/O subsystem 2335, etc. The peripherals interface 2315 enables communication between the processing units 2305 and various peripherals. For instance, the depth sensor 2378 is coupled to the peripherals interface 2315 to facilitate depth capturing operations. The depth sensor 2378 may be used with the camera subsystem 2320 to capture 3D data. The recognition method of some embodiments uses different depth maps for a same person. The depth maps may be captured at different distance ranges and may be captured with one range adjusting sensor or multiple different sensors that are set at different ranges.

Also, for instance, the motion sensor 9222 is coupled to the peripherals interface 2315 to facilitate motion sensing operations. Further, for instance, an orientation sensor 2345 (e.g., a gyroscope) and an acceleration sensor 2350 (e.g., an accelerometer) is coupled to the peripherals interface 2315 to facilitate orientation and acceleration functions.

The camera subsystem 2320 is coupled to one or more optical sensors 2340 (e.g., a charged coupled device (CCD) optical sensor, a complementary metal-oxide-semiconductor (CMOS) optical sensor, etc.). The camera subsystem 2320 coupled with the optical sensors 2340 facilitates camera functions, such as image and/or video data capturing. As indicated above, the camera subsystem 2320 may work in conjunction with the depth sensor 2378 to capture 3D data (e.g., depth map, normal map). The camera subsystem 2320 may be used with some other sensor(s) (e.g., with the motion sensor 9222) to estimate depth.

The wireless communication subsystem 2325 serves to facilitate communication functions. In some embodiments, the wireless communication subsystem 2325 includes radio frequency receivers and transmitters, and optical receivers and transmitters (not shown in FIG. 23). These receivers and transmitters are implemented to operate over one or more communication networks such as a LTE network, a Wi-Fi network, a Bluetooth network, etc. The audio subsystem 2330 is coupled to a speaker to output audio (e.g., to output different sound effects associated with different image operations). Additionally, the audio subsystem 2330 is coupled to a microphone to facilitate voice-enabled functions, such as voice recognition, digital recording, etc.

The I/O subsystem 2335 involves the transfer between input/output peripheral devices, such as a display, a touch screen, etc., and the data bus of the processing units 2305 through the peripherals interface 2315. The I/O subsystem 2335 includes a touch-screen controller 2355 and other input controllers 2360 to facilitate the transfer between input/output peripheral devices and the data bus of the processing units 2305. As shown, the touch-screen controller 2355 is coupled to a touch screen 2365. The touch-screen controller 2355 detects contact and movement on the touch screen 2365 using any of multiple touch sensitivity technologies. The other input controllers 2360 are coupled to other input/control devices, such as one or more buttons. Some embodiments include a near-touch sensitive screen and a corresponding controller that can detect near-touch interactions instead of, or in addition to touch interactions.

The memory interface 2310 is coupled to memory 2370. In some embodiments, the memory 2370 includes volatile memory (e.g., high-speed random access memory), non-volatile memory (e.g., flash memory), a combination of volatile and non-volatile memory, and/or any other type of memory. As illustrated in FIG. 23, the memory 2370 stores an operating system (OS) 2372. The OS 2372 includes instructions for handling basic system services and for performing hardware dependent tasks.

The memory 2370 may include communication instructions 2374 to facilitate communicating with one or more additional devices; graphical user interface instructions 2376 to facilitate graphic user interface processing; input processing instructions 9220 to facilitate input-related (e.g., touch input) processes and functions. The instructions described above are merely exemplary and the memory 2370 includes additional and/or other instructions in some embodiments. For instance, the memory for a smart phone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 23 are shown as separate components, it is to be understood that two or more components may be integrated into one or more integrated circuits. In addition, two or more components may be coupled together by one or more communication buses or signal lines. Also, while many of the functions have been described as being performed by one component, it is to be understood that the functions described with respect to FIG. 23 may be split into two or more integrated circuits.

While the invention has been described with reference to numerous specific details, it is to be understood that the invention can be embodied in other specific forms without departing from the spirit of the invention. In addition, a number of the figures (including FIGS. 2, 3, 4, 7, and 9) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, it is to be understood that the invention is not to be limited by the foregoing illustrative details, but rather is to be defined by the appended claims.

What is claimed is:

1. A method of performing facial recognition, the method comprising:
receiving 2D and 3D data sets relating to a person; and
automatically identifying the person by:
performing a first level facial recognition with one of the 2D and 3D data sets, and
performing a second level facial recognition with the other remaining data set.

2. The method of claim 1, wherein the 3D data set includes depth information.

3. The method of claim 2, wherein the depth information is specified in a depth map.

4. The method of claim 1, wherein the 2D data set includes a photo with the person represented with RGB values.

5. The method of claim 1, wherein the 2D data set includes a photo with the person represented with grayscale values.

6. The method of claim 1, wherein performing the facial recognition with the 3D data set comprises setting a target unit with an axis-aligned bounding box (AABB).

7. The method of claim 1, wherein performing the facial recognition with the 3D data set includes converting initial point on 2D image data to 3D data using ray-casting to increase accuracy of detection and/or recognition.

8. The method of claim 1, wherein performing the facial recognition with the 3D data set includes detecting the person's face represented in the 3D data set.

9. The method of claim 1, wherein performing the facial recognition with the 3D data set includes detecting the person's nose from the person's face.

10. The method of claim 1, wherein performing the facial recognition with the 3D data set includes finding the person's eyes.

11. The method of claim 1, wherein performing the facial recognition with the 3D data set includes detecting the person's ears or the person's lips.

12. The method of claim 1, wherein the first level facial recognition is a 3D recognition with the 3D data set, and wherein the second level facial recognition is a 2D recognition with the 2D data set.

13. The method of claim 1, wherein the first level facial recognition is a 2D recognition with the 2D data set, and wherein the second level facial recognition is a 3D recognition with the 3D data set.

14. The method of claim 1, wherein the program is programmed to switch back and forward between using 2D and 3D data.

15. The method of claim 1, wherein the first or second level facial recognition includes analyzing the geometric features of a face.

16. The method of claim 1, wherein the first or second level facial recognition includes analyzing the position information or angular information relating to a particular feature of the face or head.

17. The method of claim 1, wherein the first or second level facial recognition includes treating the 2D or 3D data to alter the person's appearance in order to recognize the person or visually identity the person.

18. The method of claim 1, wherein performing the facial recognition with the 2D data set comprises finding the pupils from the face or head represented in the 2D image.

19. A system comprising:
a first set of computing devices to capture 2D and 3D data;
a second set of computing devices to receive the 2D and 3D data from the first computing device, and perform a hybrid facial recognition with the 2D and 3D data, the hybrid facial recognition including:
receiving 2D and 3D data sets relating to a person; and
automatically identifying the person by:
performing a first level facial recognition with one of the 2D and 3D data sets, and
performing a second level facial recognition with the other remaining data set.

20. A computing device comprising:
a processing unit;
a storage storing a program for execution by the processing unit, the program comprising sets of instructions for:
receiving 2D and 3D data sets relating to a person; and
performing a hybrid facial recognition by:
using 2D data to derive data values, and
using a set of data values, which is derived from the 2D data, to perform the hybrid facial recognition with the 3D data.
